(19) United States
(12) Patent Application Publication
(10) Pub. No.: US 2008/0008443 A1
(43) Pub. Date: Jan. 10, 2008

(54) DATA MANAGEMENT SYSTEM AND METHOD

(75) Inventors: Chaucer Chiu, Taipei (TW); Mike Pan, Taipei (TW); Xin-Jun Cheng, Taipei (TW)

Correspondence Address: ISHIMARU & ZAHRT LLP, 333 W. EL CAMINO REAL, SUITE 330, SUNNYVALE, CA, 94087, US

(73) Assignee: Inventec Corporation, Taipei (TW)

(21) Appl. No.: 11/537,091

(22) Filed: Sep. 29, 2006

(30) Foreign Application Priority Data
Jun. 30, 2006 (TW) 095123783

(51) Int. Cl. H04N 5/91

(52) U.S. Cl. 386/83

(57) ABSTRACT

A data management system and method is disclosed, which is applicable to an AV data processing system capable of acquiring and storing AV data. The data management method includes grouping AV data acquired by the AV data processing system into a plurality of related index data and statistic data, comparing the related index data and statistic data, and executing corresponding addition/deletion operations based on comparing results, thereby maintaining an integrity of the AV data acquired by and stored in the AV data processing system.

### BACKGROUND OF THE INVENTION

1. Field of the Invention

This invention relates generally to data management systems and methods, and more particularly, to a data management system and method applicable to an AV data processing system which acquires and stores AV data.

2. Description of Related Art

A video monitoring system can monitor and record monitored contents, and is widely used in places where needs to be monitored for security reason, such as warehouses, supermarkets, amusement places, major traffic intersections, and banks, etc. Compared with the traditional video monitoring system, which stores and plays recorded data by using of a magnetic tape, a digital video monitoring system has higher resolution by applying digital processing, and, it provides users the convenience of acquiring a recorded data of any specific time, as well as any specific camcorder instantly at any time, besides, there are many other advantages, such as, making a copy and, meanwhile, maintaining the same sharpness as the original recorded data. Therefore, the digital video monitoring system has become the developing trend of the domain of video monitoring.

In spite of the many kinds of advantages of digital video monitoring system, there are still many problems in a real application. A digital video monitoring system acquires the AV data of a monitored place by the camcorders of the system; next, via the digital recording system (DRS), each of the acquired AV data is numbered, compressed, indexed, and then, stored. Therefore, the stored data of a digital video monitoring system includes a plurality of related index data and statistic data (two sets of data), the user must use the index data to access and read the related statistic data. For this reason, if a digital video monitoring system is processing an AV data, and, at the same time, power failure or other incident happens, the following problems will arise easily: the index data will lost or be damaged, therefore, users can not access and read the related statistic data; or, a statistic data related to an index data is non-existing or incomplete, therefore, while an index data is readable, the related statistic data is not accessible, and consequently, makes the playing of recorded data impossible.

Hence, it is a highly urgent issue in the industry for how to provide a technique which can solve the above-mentioned disadvantages in the prior art.

### SUMMARY OF THE INVENTION

In views of the above-mentioned problems of the prior art, it is a primary objective of the present invention to provide a data management system and method which maintains the integrity of AV data acquired and stored by an AV data processing system.

It is another objective of the present invention to provide a data management system and method, which can be used to avoid the waste of data storage space.

To achieve the above-mentioned and other objective, a data management system is provided according to the present invention. The data management system is applicable to an AV data processing system capable of acquiring and storing AV data. The data management system includes a data grouping module for grouping AV data acquired by the AV data processing system into a plurality of related index data and statistic data, a comparison module for comparing the related index data and statistic data derived from the data grouping module, and a processing module for executing corresponding addition/deletion operations based on comparing results derived from the comparison module, thereby maintaining an integrity of the AV data acquired and stored by the AV data processing system.

In one of the better embodiments of the data management system of the present invention, the AV data processing system is a digital AV monitoring system; the index data includes an initial recording time, an ending recording time, a camcorder serial number, a camcorder name, a recording item name, and a size of recording item, wherein the size of recording item is used for determining whether the AV data have a correct size or not; the statistic data includes a key character corresponding to the recording item name, a statistic camcorder serial number corresponding to the camcorder serial number, a length of recording time corresponding to the initial recording time and ending recording time, a yes/no of completing recording, and a statistic initial recording time corresponding to the initial recording time, wherein the yes/no of completing recording is used for determining whether the AV data are successfully acquired or not; the processing module deletes the index data and the statistic data if the statistic data related to the index data do not exist or are incomplete, or creates new related index data based on the statistic data if the index data related to the statistic data do not exist or are incomplete.

The present invention provides a data management method applicable to an AV data processing system capable of acquiring and storing AV data. The data management method includes the following steps: (1) grouping AV data acquired by the AV data processing system into a plurality of related index data and statistic data, (2) comparing the derived related index data and statistic data, and (3) executing corresponding addition/deletion operations based on comparing results derived from step (2), thereby maintaining an integrity of the AV data acquired and stored by the AV data processing system.

In one of the better embodiments of the data management method of the present invention, the AV data processing system is a digital AV monitoring system; the index data includes an initial recording time, an ending recording time, a camcorder serial number, a camcorder name, a recording item name, and a size of recording item, wherein the size of recording item is used for determining whether the AV data have a correct size or not; the statistic data includes a key character corresponding to the recording item name, a statistic camcorder serial number corresponding to the camcorder serial number, a length of recording time corresponding to the initial recording time and ending recording time, a yes/no of completing recording, and a statistic initial recording time corresponding to the initial recording time, wherein the yes/no of completing recording is used for determining whether the AV data are acquired successfully or not; the index data and the statistic data are deleted if the statistic data related to the index data do not exist or are incomplete, or new related index data are created based on the statistic data if the index data related to the statistic data do not exist or are incomplete.

In summary, the data management system and method of the present invention, first, groups AV data acquired by the AV data processing system into a plurality of related index data and statistic data, next, compares the plurality of related index data and statistic data derived from the result of dividing, then, based on the result of comparing, executes the corresponding operation of addition/deletion to maintain the integrity of the AV data acquired and stored by the AV data processing system, meanwhile, to increase the usage rate of data storage space.

### BRIEF DESCRIPTION OF DRAWINGS

The present invention can be more fully understood by reading the following detailed description of the preferred embodiments, with reference made to the accompanying drawings, wherein:

FIG. 1 is a functional block diagram of an exemplary embodiment of a data management system according to the present invention; and

FIG. 2 is an operational flow chart of an exemplary embodiment of a data management method according to the present invention.

### DETAILED DESCRIPTION OF PREFERRED EMBODIMENTS

The following illustrative embodiments are provided to illustrate the disclosure of the present invention, these and other advantages and effects can be apparently understood by those in the art after reading the disclosure of this specification. The present invention can also be performed or applied by other different embodiments. The details of the specification may be on the basis of different points and applications, and numerous modifications and variations can be devised without departing from the spirit of the present invention.

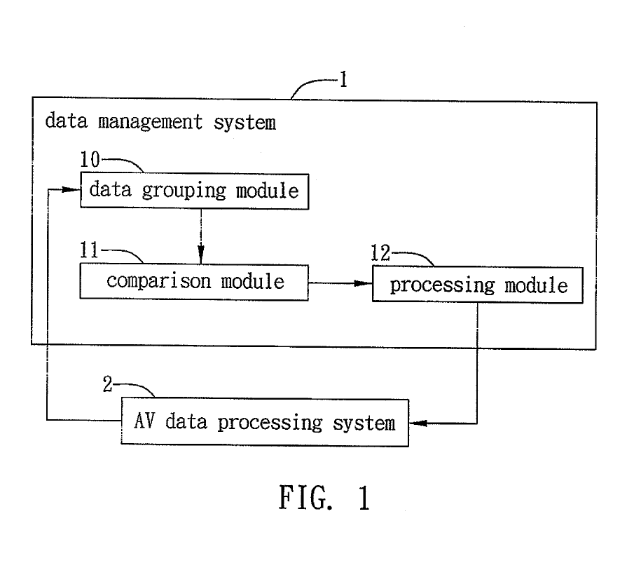

Please refer to FIG. 1, which is a functional block diagram of an audio/video (AV) data processing system 2 and a data management system 1 of the preferred embodiment according to the present invention. The data management system 1 is applicable to the AV data processing system 2, which is capable of acquiring and storing AV data. According to the preferred embodiment, the AV data processing system 2 is a digital AV monitoring system. The data management system 1 comprises a data grouping module 10, a comparison module 11, and a processing module 12.

The data grouping module 10 groups AV data acquired by the AV data processing system 2 into a plurality of related index data and statistic data. According to the preferred embodiment, the index data includes an initial recording time, an ending recording time, a camcorder serial number, a camcorder name, a recording item name, and a size of recording item. The size of recording item is used for deciding whether AV data have a correct size or not. The statistic data includes a key character corresponding to the recording item name, a statistic camcorder serial number corresponding to the camcorder serial number, a length of recording time corresponding to the initial recording time and ending recording time, a yes/no of completing recording, and a statistic initial recording time corresponding to the initial recording time. The yes/no of completing recording is used for deciding whether the AV data are acquired successfully or not.

The comparison module 11 compares the related index data and statistic data derived from the data grouping module 10.

The processing module 12 executes corresponding addition/deletion operations based on comparing results derived from the comparison module 11, thereby maintaining the integrity of the AV data acquired and stored by the AV data processing system 2. If the comparing results indicate that the statistic data related to the index data do not exist or are incomplete, the processing module 12 deletes the index data and the statistic data. If the comparing results indicate that the index data related to the statistic data do not exist or are incomplete, the processing module 12 creates and adds new related index data based on the statistic data.

To further illustrate the features and effects of the present invention, in the following exemplary embodiment the AV data processing system 2 is a digital AV monitoring system installed in a residential area for security monitor, and the digital AV monitoring system includes a camcorder. First, the camcorder of the digital AV monitoring system 2 begins to capture AV data at for example 20:00 of a specific date. Next, the data grouping module 10 groups the AV data acquired by the camcorder into a plurality of related index data and statistic data by the unit of hour. For example, at the time of 23:01, related index data A and B and statistic data a, b, and c have been acquired, and index data C related to the statistic data c are being processed. If an incident of power failure happens at this right moment, the index data C can not be acquired completely. In this situation, when the comparison module 11 compares the related index data and statistic data derived from the data grouping module 10 (compares the index data A, B and, C with statistic data a, b, and c respectively), the result of comparing is that index data C related to statistic data c is incomplete. In this situation, the processing module 12 creates a new related index data C′ based on statistic data c, therefore, while reading the AV data, the statistic data of a, b, and c can be accessed by index data of A, B, and C′ respectively, thereby, maintaining the integrity of data as a purpose of the present invention.

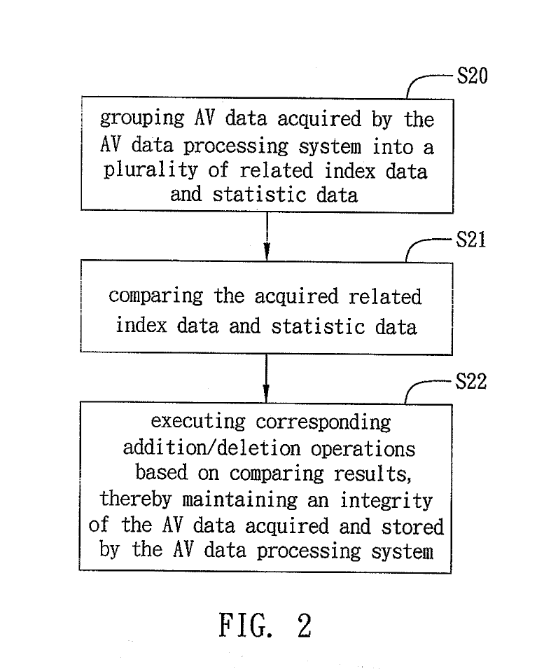

Please refer to FIG. 2, which is a flow chart illustrating the operational flow of an exemplary embodiment of the data management method in the present invention. As illustrated, the process begins at step S10: divide an AV data acquired by the AV data processing system into a plurality of related index data and statistic data. Proceed to step S11.

In step 11, compare the plurality of related index data and statistic data derived from step S10. Next, proceed to step S12.

In step 12, execute the corresponding operation of addition/deletion based on the result of comparing derived from step S11, thereby, maintaining the integrity of the AV data acquired and stored by the AV data processing system.

In the present exemplary embodiment, based on the result of comparing, if a statistic data related to an index data does not exist or is incomplete, deletes the index data and the statistic data; if an index data related to a statistic data does not exist or is incomplete, create a new related index data to fit the statistic data.

It should be noted that the detailed description of the steps in the data management method has been covered in the detailed description of the data management system described previously; therefore, there is no need of a repeat herein.

In summary, the data management system and method of the present invention makes the use of the inter-operation of a data grouping module, a comparison module, and a processing module. First, divide an AV data acquired by an AV data processing system into a plurality of related index data and statistic data, next, compare the plurality of related index data and statistic data, then, based on the result of comparing, execute the corresponding operation of addition/deletion, thereby, maintaining the integrity of the AV data acquired and stored by the AV data processing system, as well as enhancing the usage rate of data storage space, and reducing the damage caused by incidents (e.g. power failure) to the minimum lost, further enhancing the monitoring function of a video monitoring system to the maximum.

The foregoing descriptions of the detailed embodiments are only illustrated to disclose the features and functions of the present invention and not restrictive of the scope of the present invention. It should be understood to those in the art that all modifications and variations according to the spirit and principle in the disclosure of the present invention should fall within the scope of the appended claims.

What is claimed is:

1. A data management system applicable to an audio/video (AV) data processing system capable of acquiring and storing AV data, the data management system comprising:
a data grouping module for grouping the AV data acquired by the AV data processing system into a plurality of related index data and statistic data;
a comparison module for comparing the related index data and statistic data derived from the data grouping module; and
a processing module for executing corresponding addition/deletion operations based on comparing results derived from the comparison module, thereby maintaining an integrity of the AV data acquired and stored by the AV data processing system.

2. The data management system of claim 1, wherein the AV data processing system is a digital AV monitoring system.

3. The data management system of claim 1, wherein the index data includes an initial recording time, an ending recording time, a camcorder serial number, a camcorder name, a recording item name, and a size of recording item.

4. The data management system of claim 3, wherein the size of recording item is used for determining whether the AV data have a correct size or not.

5. The data management system of claim 3, wherein the statistic data includes a key character corresponding to the recording item name, a statistic camcorder serial number corresponding to the camcorder serial number, a length of recording time corresponding to the initial recording time and ending recording time, a yes/no of completing recording, and a statistic initial recording time corresponding to the initial recording time.

6. The data management system of claim 5, wherein the yes/no of completing recording is used to decide whether the AV data is successfully acquired or not.

7. The data management system of claim 1, wherein the processing module deletes the index data if the statistic data related to the index data do not exist or are incomplete, or creates new related index data based on the statistic data if the index data related to the statistic data do not exist or are incomplete.

8. The data management system of claim 7, wherein the processing module further deletes the statistic data based on the comparing results derived from the comparison module if the statistic data related to the index data do not exist or are incomplete.

9. A data management method applicable to an AV data processing system capable of acquiring and storing an AV data, the data management method comprising the following steps:
(1) grouping the AV data acquired by the AV data processing system into a plurality of related index data and statistic data;
(2) comparing the grouped related index data and statistic data; and
(3) executing the corresponding addition/deletion operations based on comparing results derived from step (2), thereby maintaining an integrity of the AV data acquired and stored by the AV data processing system.

10. The data management method of claim 9, wherein the AV data processing system is a digital AV monitoring system.

11. The data management method of claim 9, wherein the index data includes an initial recording time, an ending recording time, a camcorder serial number, a camcorder name, a recording item name, and a size of recording item.

12. The data management method of claim 11, wherein the size of recording item is used for determining whether the AV data have a correct size or not.

13. The data management method of claim 11, wherein the statistic data includes a key character corresponding to the recording item name, a statistic camcorder serial number corresponding to the camcorder serial number, a length of recording time corresponding to the initial recording time and ending recording time, a yet/no of completing recording, and a statistic initial recording time corresponding to the initial recording time.

14. The data management method of claim 13, wherein the yes/no of completing recording is used for determining whether the AV data are acquired successfully or not.

15. The data management method of claim 9 further comprising deleting the index data based on the comparing results if the statistic data related to the index data do not exist or are incomplete, or creating new related index data based on the statistic data if the index data related to the statistic data do not exist or are incomplete.

16. The data management method of claim 15 further comprising deleting the statistic data if the statistic data related to the index data do not exist or are incomplete.
